(19) United States
(12) Patent Application Publication
(10) Pub. No.: US 2004/0204120 A1
(43) Pub. Date: Oct. 14, 2004

(54) Portable telephone

(76) Inventor: Lavon Jiles, Chicago, IL (US)

Correspondence Address: RICHARD C. HIMELHOCH, 311 S. WACKER DRIVE, 53RD FLOOR, CHICAGO, IL, 60606-6622, US

(21) Appl. No.: 10/200,053

(22) Filed: Jul. 19, 2002

(51) Int. Cl. H04M 1/00

(52) U.S. Cl. 455/564; 455/556.1; 455/569.1

(57) ABSTRACT

A cellular telephone with a keypad located adjacent to a speaker near the top of the phone and a display adjacent to a microphone near the bottom of the phone, the keys configured in alternating triangles and spaced to maximize the distance between them. The telephone has a data memory to store a directory of telephone numbers, and a scanning device to read and store data from a card into the data memory. The telephone further includes a hands-free headset that can be affixed to the handset when not in use and can also be attached to the handset by a flexible retractable cord. The headset can telescopically adjust to extend to the proximity of the user's mouth and ear and collapse to attach to the handset, the cord, if applicable, conveniently retracting into a manageable storage configuration. The cellular telephone may further include a short range transmitter and receiver for transmitting or receiving information to or from another similarly equipped phone or device.

### TECHNICAL FIELD

The present invention is generally directed to a portable, hand-held telephone apparatus with enhanced user interface ergonomics for added convenience and ease of use; and more particularly, to a cellular phone having input keys positioned proximate the speaker in the upper portion of the cellular phone, and a display positioned below the input keys proximate to the microphone of the telephone in the lower portion of the cellular telephone.

The present invention is also generally directed to an improved portable hand-held telephone apparatus capable of obtaining and storing information maintained on a card, and more particularly to a cellular phone having an integral scanning device or mechanism capable of reading, information maintained in a magnetic strip or bar code, or other similar format on a card.

The present invention is also generally directed to a cellular phone having a short range transmitter and receiver for transmitting or receiving data to or from another telephone or other electronic device having similar components.

The present invention is also generally directed to a portable hand-held telephone apparatus capable of storing a hands-free headset, and more particularly to a cellular telephone having an integrally formed receptacle or compartment adapted to fit and hold a hands-free headset when the headset is not in use.

### BACKGROUND OF THE INVENTION

Although cellular telephone technology has made major advances in recent years, there are several areas where improvement can still be made. Such improvements can enhance the design and performance of such phones, as well as possibly other portable telephones or communication devices.

Portable telephones, especially cellular telephones, are designed to be easily carried or moved about. A portability requirement generally forces telephone size to be as small and light as possible while providing all standard phone functions.

People using cellular phones are frequently in transit. That is, many use their phones while commuting. This may include either walking, riding, or driving. While commuting, phone users' hands are frequently allocated to other chores. They may have their hands on a steering wheel when driving, carrying a parcel when walking, or even tucked into a pocket, reaching for a personal possession or trying to stay warm. Because of the multitasking habits of commuters, it is preferred that their cell phones can be operated with only one hand.

As cellular phones are designed to be smaller and lighter, the user interface must naturally shrink in response. The user interface typically includes a plurality of input keys or buttons, and a display. The display of a cell phone is traditionally located near the top of the phone, and the keys or buttons are located close to the bottom of the phone below the display. When the phone is held in one's hand, the display is generally positioned nearest the index finger and thumb while the keys are positioned nearest the portion of the palm that meets the wrist. From this angle, the position of the keys make it difficult for access by the thumb of that holding hand. That is, the dimensions of the keys combined with the configuration and location of the keys, substantially near the bottom of the phone, yields to difficulty in entering telephone data with one hand, especially for the lowest positioned keys.

For one-handed operation, the phone has to be either awkwardly balanced on the user's fingers, rather than resting the phone in their palm, to dial the bottom buttons, or the user's thumb must be uncomfortably bent or extended to dial the telephone. An improved design is needed to resolve this problem.

Another area that can be improved is the mechanism for entering data into a cellular phone. Many cellular phones contain a data memory for the storage of phone numbers and sometimes an associated text field. However, difficulties with pushing the keys makes data entry cumbersome. Also, there is a growing desire to associate other alphanumeric fields, such as email addresses, web addresses, business and personal information, with the phone number, in memory. Frustratingly, alpha characters are the most challenging type of information to be entered into the data memory with the abbreviated keypad of a cellular phone. A valuable saving of both time and effort would result from a more convenient way of entering data into the phone's memory.

Cellular and other portable phones (e.g., cordless phones) are often used with a hands-free headset (i.e., a headset having a piece that fits into the ear or is clipped to the ear, and a microphone extending from the earpiece or on the cord connecting the earpiece to the phone). Such headsets are generally plugged into and removable from the portable phone. However, a problem exists as to what to do with the headset when not being used. Because the headset is separate from the phone, it can be damaged or lost. In some instances, the user will typically wrap the headset wire around the phone or otherwise coil the headset and secure it with a rubber band or the like. However, these methods of securing the headset have several drawbacks. First, it is an inconvenience to the user to wrap or coil the headset and secure it for storage or transportation. Even if the headset is wrapped or coiled, it is susceptible to being damaged or lost when not in use. Thus, an improved manner of transporting and storing a hands-free headset is needed.

### SUMMARY OF THE INVENTION

The present invention provides a hand-held, portable, cellular telephone with improved user interface ergonomics for added convenience and ease of use. The present invention also provides a means for easily inputting information into a cellular phone. Additionally, the present invention provides a portable phone with a built in receptacle or compartment for holding a hands-free headset.

In one embodiment, the invention comprises a portable cellular telephone, or cell phone, with standard telecommunication interface capabilities for sending and receiving information. The cellular phone has a set of keys for entering data and a display for viewing data. The cellular phone has a speaker to generate an audible signal and a microphone to receive an audible signal. In contrast to prior cell phones, the phone of the present invention has keys located substantially near the top of the cell phone adjacent to the speaker, and a display located substantially near the bottom of the phone adjacent to the microphone. The position of the keys and display are particularly advantageous when attempting to use the phone with only one hand. To utilize a cellular phone having a display placed below the input keys, a user would place the handset in the palm of his hand with the display closest to the wrist and the buttons closest to the fingers. The cellular phone can then be easily dialed with one hand by pushing the buttons with the thumb without requiring undo bending of the thumb or precariously balancing the phone in the user's fingertips.

Additionally, the cellular telephone includes touch button keys having a triangular-shaped design that alternates every other button to allow as much space between them as possible. The keys are positioned in the top portion of the phone at angles that maximize the space between them. This feature limits the number of mis-dials caused by “fat-fingering” the keys. “Fat-fingering” occurs when the user attempts to push one button, but inadvertently strikes two keys concurrently. This can result in a dialing error where either a second undesired digit is entered or the improper digit is entered. Adequate spacing between keys along with the triangular shape and configuration will serve to minimize “fat-fingering” errors.

In another embodiment, a cellular telephone is provide with a scanning mechanism or device for scanning information or data from a data carrying medium, such as a business card or credit card, for placement in a database or other memory in the phone. The scanning device is preferably in the form of a card-reading slot in the housing of the phone. The scanning device can read data from a card that is slid or swiped through the slot. After scanning a card, the card contents are available for manipulation by the phone user. The data may be stored in the memory of the telephone as it was read or can be edited, using the keypad. Moreover, the scanned phone number and identity of the card owner can be placed directly in, or made available to the automatic speed dial portion of the telephone's electronic system.

The swipe slot of the scanning device, or scanner, is preferably positioned at one end of the telephone housing, but may be located along the side of the housing or elsewhere on the telephone. The scanning device can be configured to read bar codes, magnetic strips, optical data, or use a variety of other media or reading methods for entering and storing information.

The card containing data may be one of as many unique formats as available for transferring data. The card can be of numerous forms, but is preferably an electronic card approximately the size of a standard business card, 2 inches by 3.5 inches. The preferred location of the data on the card is along the 2 inch width of the card, to provide the telephone input with a shorter swipe.

Data on the card can be a phone number and/or other personal contact information such as an email address, web page, fax number, pager number, and home or office address. The card can even carry enough data to load a conventional resume into the telephone's data memory.

In another embodiment, a cellular telephone is provided that includes a receptacle or compartment integrally formed in the phone to accommodate and secure a hands-free headset to the cellular phone. The headset can be wireless or include a wire that is connected to the phone. Moreover, the wire can be retractably connected to the phone. The headset operative components may comprise an earpiece speaker only, with a microphone in the handset or along the cord connecting the earpiece to the phone, or can include a mouthpiece microphone extending from the earpiece. The headset can be snapped, clipped, hooked, or attached by any other means, to a receptacle on the headset. The headset can be adequately secured to the handset, but may also be readily removed from the receptacle in times of use.

Headsets having both an earpiece loudspeaker and a mouthpiece microphone may have a telescopic feature that allows the distance between the ear and mouth pieces to be adjusted. Typically, a user will lengthen the distance when the headset is in use, to optimize reception and communication clarity. When no longer in use, the headset can be collapsed into a compact form that can be simply fitted into and fastened to the handset receptacle. In a preferred embodiment, the receptacle is formed in the housing of the cellular phone and is specifically configured to match the contours of a particular headset.

The hands-free headset can have a wire or cord connected to the phone or have a wireless connection. Headsets connected to the phone by a cord preferably have a procedure for retracting the cord into or onto the phone. The headset cord can retract or be spooled into or onto the handset by a number of methods including, but not limited to, manually hand wrapping the cord around a spool device on the handset, spring coil rewinding the cord, or employing a motor-driven rewind device. Preferably, the cellular phone includes a retract button that retracts the cord into the housing of the phone when pressed. The cord can be retracted to a point that allows no exposed cord slack, yet still allows the headset to be placed in the receptacle of the handset.

Further aspects of the invention are disclosed in the detailed description of the preferred embodiment, the drawings and the claims.

### BRIEF DESCRIPTION OF THE DRAWINGS

FIG. 1 is a perspective view of an embodiment of the user interface side of a cellular telephone and a data card of the present invention;

FIG. 2 is a perspective view of the palm-side of the cellular telephone of FIG. 1, holding a headset in a receptacle;

FIG. 3 is a perspective view of the palm-side of the cellular telephone of FIG. 2 wired with the hands-free headset extended for use; and,

FIG. 4 is a cross-sectional view of the cellular telephone of the present invention.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

FIG. 1 discloses an embodiment of the user interface side of a cellular telephone handset referenced by the number 10. The telephone 10 is to be held in the palm of the hand of a user with the user interface side up. Near the bottom of the phone and typically held close to the wrist of the user, is a mouthpiece microphone 12. The mouthpiece microphone 12 allows a voice or other audible signal to be transmitted to another telephone or receiver. Also near the bottom of the telephone 10 is a display 14. The display 14 can be, for example, a liquid crystal display (LCD) or a light emitting diode (LED) display. The display 14 is capable of showing data associated with the operation of the telephone 10. The display 14 can also list alpha-numeric text associated with telephone numbers or other data. The characters and numbers can be entered by the user, pulled up from a menu or directory list, downloaded from a data input device, or input to the phone by other means.

In the embodiment disclosed in FIG. 1, the top portion of the phone contains a speaker 18. The speaker 18 transmits voice or an audible signal to the ear of the user. The speaker 18 is positioned as close to the top of the phone as possible to maximize the distance between the speaker 18 and the microphone 12. The maximized distance is advantageous because cellular phones are made so small that the distance is less than the average distance between the ear and mouth of an average cell phone user. Adjacent to the speaker 18 is a set of touch button keys 16. The keys 16 represent at least the numerical digits 0 through 9 and also other additional keys for control functions and user input, typically provided in cellular telephones. The keys 16 are triangular shaped and alternate orientation every other button to allow as much space between the keys 16 as available. This configuration provides a maximum amount of surface area on the face of the keys 16 to allow alpha numeric characters to label each key.

The benefit of having the keys 16 near the top of the phone, close to the forefinger of the user while resting in the palm of the hand, is the simplicity of one-handed operation by pressing the keys with a thumb. When held in this manner, the user can clearly view the display while inputting numbers with the user's thumb. Moreover, the user is not required to either severely bend the user's thumb to press lower buttons or precariously position the phone off the user's palm and onto the user's fingertips, to get at the lower buttons (i.e., without severely bending the user's thumb). Instead, the phone can be held comfortably and securely in the user's palm, with all buttons easily accessible to the user's thumb and the display clearly visible.

While the cellular phone shown in FIGS. 1-3 is of one piece construction (not including the hands-free headset), the arrangement of the display and input keys can also be implemented in a flip type phone (i.e., a two piece phone having a first piece connected to the second piece by a hinge). In this instance, the lower piece or portion of the phone will include the display and the microphone, and the upper piece or portion will include the input keys and the speaker.

In alternative embodiments of the invention, the cellular telephone 10 has at least one data scanning device 20 at the very top of the phone 10. The data scanning device 20 includes a slot shaped to accept a data card 22 containing relevant information. The data scanning device 20 is one method of inputting data into the memory of the telephone 10. The scanner can be configured to read several data types from various media formats, including, but not limited to, bar codes, magnetic and electronic stored information. The software associated with reading data from the card 22 can also automatically place the card owner's phone number and additional identifying information in a conventional automatic dial database on the telephone 10. By implementing this feature, the cellular phone user does not have to manually input the phone number or other data. This is particularly convenient since manually entering phone number and associated name into memory is generally a cumbersome task. Conventional software code can be utlized to implement this functionality.

The preferred data card 22 of the present embodiment is sized similar to a standard business card, having a length of approximately 3.5 inches and a width of approximately 2 inches. However, other dimensions can be used. The data card 22 shown has a magnetic strip 24 which runs along the shorter width of the card 22 (however, the strip can run along the length of the card as well). The magnetic strip 24 of the card 22 contains the data that is downloaded into the telephone's memory by swiping the card 22 through the slot 20. The downloaded data may be seen on the display and is then available for the operator to edit or use. Instead of, or in addition to, the magnetic strip, the card may be provided with a bar code or other slot device readable formats.

The embodiment of the invention of FIG. 1 has a headset port 26 that allows for the connection of a plug. A headset cord may be plugged into the headset port 26 of the phone handset 10 when the user desires to operate the phone 10 in a hands-free method, a feature particularly useful when driving while phoning.

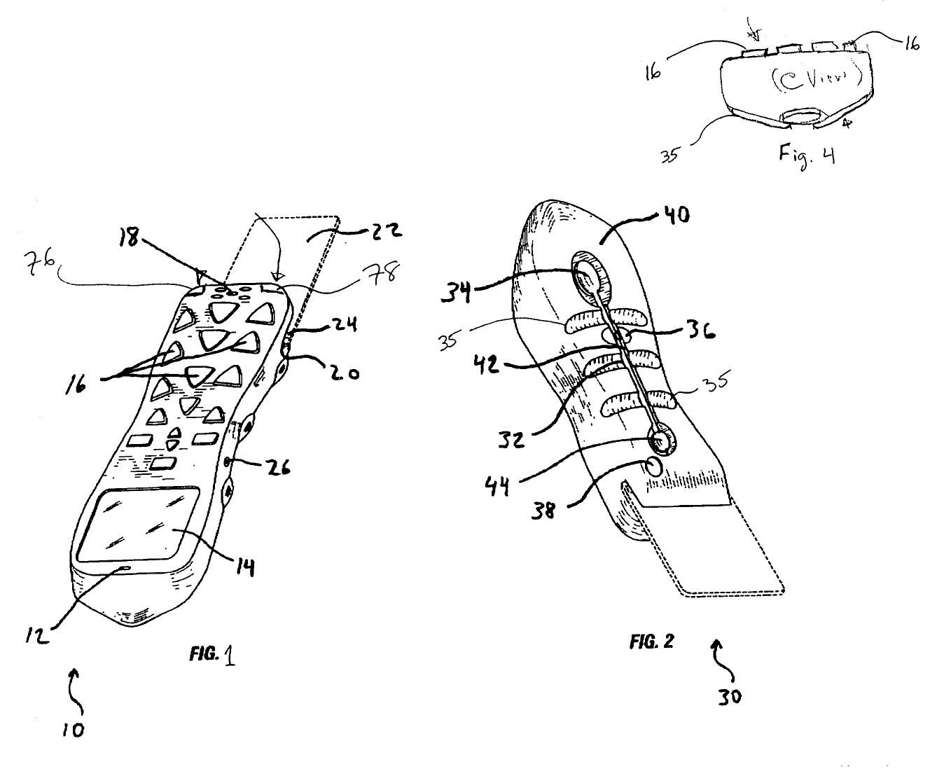

Another aspect of the portable cellular telephone 10 is shown in the palm side view of FIG. 2. The phone 30 is shown from where it would be held in the palm of the user's hand. The phone 30 has an integrally formed receptacle 32 built into the housing 40 on the palm side. The receptacle 32 is configured to accept and hold a hands-free headset 42. Preferably, the receptacle 32 is specifically configured to match the contours of a particular headset design. However, the receptacle 32 could also have a more general shape to provide for a large number of different headset designs or shapes. Rubber pads 35 extend across the back of the cellular phone. As shown in cross-section in FIG. 4, the rubber pads 35 also slightly project from the back surface of the phone. The pads 35 help prevent the phone from slipping from a user's hand. FIG. 4 also shows the palm side back surface as being somewhat v-shaped (in cross-section). This provides a more comfortable grip of the cellular phone.

The hands-free headset 42 shown comprises an earpiece speaker 34 and a mouthpiece microphone 44. The headset 42 can be attached to the palm side of the handset 30 at the receptacle 32. The headset 42 is stored in the receptacle 32 and secured to the phone when not in use. This attachment to the receptacle 32 keeps the headset 42 from being lost, mislaid, or inopportunely separated from the rest of the phone. The receptacle 32 also protects the headset from damage when not in use. The headset 42 may also be removed from the handset 30 with the release mechanism 36. The release mechanism 36 pops the headset 42 from the receptacle 32 when pressed.

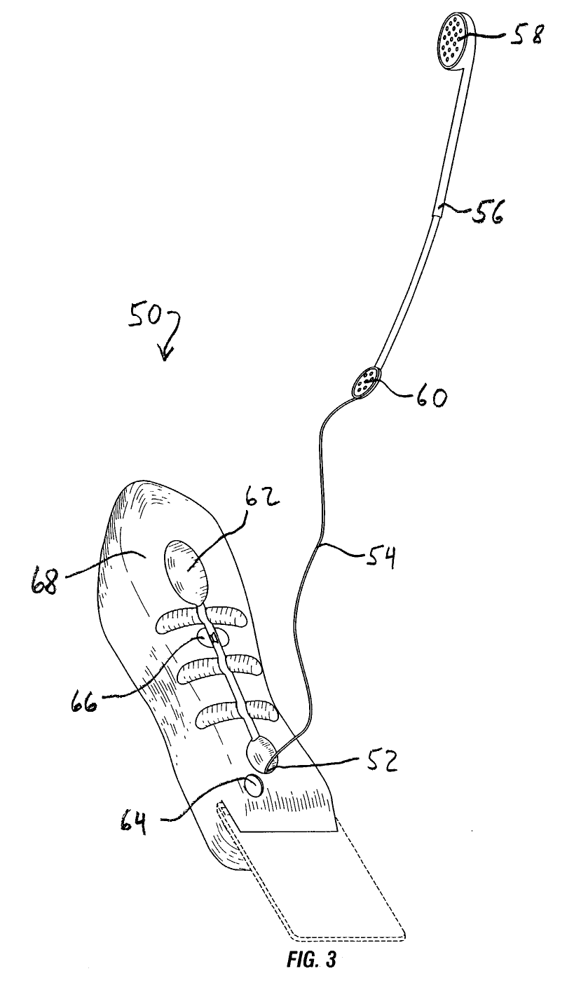

FIG. 3 shows the headset 56 removed from the receptacle 32. Although the receptacle 32 is preferably in the palm side of the cellular phone, it can be in other positions or locations of the handset, including, but not limited to the sides, top, bottom or even the user interface side of the telephone.

The headset 56 has a mouthpiece microphone 60, an earpiece speaker 58 and a cord 54 that attaches to the handset (however, the hands-free headset may be wireless). The headset 56 shown in FIG. 3 is telescopically adjustable so that the distance between the mouthpiece 60 and earpiece 58 can be altered. A user would generally extend the distance to approximate the relative distance between his or her mouth and ear, effectively optimizing communication clarity. The benefit of stabilizing the microphone 60 is also achieved by this manner of use. This is accomplished by gently pulling the mouthpiece 60 from the earpiece 58. When the headset 56 is no longer in use, the distance between the mouthpiece 60 and earpiece 58 is preferably minimized by collapsing the headset 56. In the compacted state, the headset 56 can be secured and stored in the receptacle 66 of the handset 68, appearing as the headset of FIG. 2. When the headset 56 is needed again, it can be removed from the receptacle 62 by pressing the release mechanism 66.

FIG. 3 shows an embodiment of the invention having a headset 56 that is permanently attached to the handset 68 by a cord 54. The cord 54 can be the communication path between the microphone 60 and/or the speaker 58 and the handset 68. The cord 54 serves another purpose of connecting the headset 56 and handset 68 to avoid their physical separation. The connection point for the cord 54 is at the orifice 52. In an embodiment of the invention, the cord 54 can be retracted into the housing of the handset. The retraction of the cord 54 occurs when the retract button 64 is pressed. The cord 54 is pulled into the handset for ease of storage. The method of retraction may be spring-wound, motorized, manual or performed by other methods. If manual, the phone will include a turnable knob or lever to reel in the cord about a spool. The cord 54 can be retracted up to the point where the telescopic portion of the headset 56 can be attached to the receptacle 62.

To use the headset and handset of FIG. 3 from a stored configuration, the user first presses the release mechanism 66. The release mechanism 66 allows the removal of the headset 56 from its secured storage position in the receptacle 62. The user lightly tugs the headset 56 away from the handset 68 to extend the length of the cord 54. Next, the telescopic feature of the headset 56 can be extended to adjust to the mouth and ear of the user. Then the handset is placed palm side down in the palm of the hand of the user. The user then has access to the keys and display on the user interface side of the phone described in FIG. 1.

According to another aspect of the invention, the cellular telephone has a short range infrared transmitter 76 and receiver 78 located at the speaker 18 end of the phone. The infrared devices 76, 78 enable the telephone to transmit and receive information. Two such phones pointed at each other can transfer stored data from one phone to another at the push of a button. For example, pressing one button can transfer a phone number, address, web address, or resume information to other similarly equipped telephones or other devices. Other information that may be stored and/or transferred by the phone are: social security numbers, driver's license numbers, insurance policy numbers (e.g., car, house, life). All of this information can be made accessible via the menu shown on the display.

Another use of the transmitting and/or receiving devices 76 and 78 is for the purchase or payment of goods or services. In operation, the user would scroll through the telephone menu to select an option, such as “PURCHASE” or “BUY.” A data file containing the appropriate information necessary to purchase goods or services (such as credit or debit card information stored in the phone's memory) can be transferred to a receiving device or computer (e.g., a computerized cash register having a corresponding receiver). Once the information is received by the receiving device, that device may automatically print any necessary corresponding documentation (e.g., a bill or a receipt). The only pending requirement to complete the exchange is the possible addition of a confirming signature. An example of an interaction using the invention occurs when checking into a hotel. The user can press the proper telephone buttons and aim the phone at the hotel computer, thereby transmitting all the information that the hotel needs to rent out a room. A similar exchange would happen when purchasing goods. The user can scroll through the menu to select BUY, aim the phone at the appropriately designed cash register, then push the transfer button. The information is then transferred and can include credit or debit card numbers and any other data that is necessary. The transaction can occur with airline agencies, gas stations, stores, toll booths, hospitals, etc. The phone can be used in the place of credit or debit card. These numbers will be scanned or programmed in the unit and transmitted only after a PIN code has been satisfied. The phone can scan in all credit or debit card numbers directly from the cards and display the name, number, expiration date and other required information. Once the compatible infrastructure of computer, register, fast pass, and similar equipment is in place, credit cards can be left at home. The telephone can replace all magnetic strip cards of the user.

The phone can also be easily programmed to keep a record of all transactions. Specifically, the telephone may include a database memory that contains an itemized list of its transactions. The database can be edited and manipulated to provide applicable information summaries including periodic totals of credit or debit charges.

Additionally, the phone can be provided with certain security features. For example, the phone can be programmed for remote shut down. If the phone is misplaced, lost or stolen, the owner can dial the cellular phone's number plus a designated code (e.g., a pin number) which would cause the phone to shut down operations until another code is received. This would effectively lock out anyone else from using the phone (and especially, the credit card information stored therein). The phone could also be programmed to purge the memory of certain information upon the owner dialing another designated code (or entering the pin number twice). When shut down, the phone can be programmed to flash the owner's contact number on the display, and the only operation permitted would be to call that number. This function is more applicable if the phone is lost as apposed to stolen. Moreover, because the phone contains important personal and financial information, the phone can be programmed to shut down or go into a “sleep mode” if not used in a certain amount of time, thus requiring reentry of a pin number to reactivate the phone and obtain access to such information. However, the phone may retain the ability to receive or make phone calls in such mode.

While specific embodiments have been illustrated and described, numerous modifications are possible without departing from the spirit of the invention, and the scope of protection is only limited by the scope of the accompanying claims.

I claim:

1. A portable cellular telephone having an automatic dialing function comprising:
a cellular telephone housing having a set of input keys and a display;
a speaker for generating an audible signal within a first portion of said housing, and a microphone for receiving an audible signal within a second portion of said housing;
a scanning device connected to said telephone housing for reading data from a data carrying medium and placing said data in a memory within said housing, said data including a telephone number, wherein said automatic dialing function is capable of automatically dialing said telephone number placed in said memory by said scanning device.

2. The portable cellular telephone of claim 1 wherein the scanning device is positioned in a swipe slot in said housing of said cellular telephone.

3. The portable cellular telephone of claim 1 wherein said data carrying medium is a card having a magnetic strip containing said data.

4. The portable cellular telephone of claim 3 wherein the scanning device is designed to read a magnetic strip.

5. The portable cellular telephone of claim 4 wherein the card has a length of 3.5 inches and a width of 2 inches.

6. The portable cellular telephone of claim 5 wherein said magnetic strip runs along the width of the card.

7. The portable cellular telephone of claim 3 wherein the card contains personal contact data.

8. The portable cellular telephone of claim 3 wherein the card contains resume information.

9. The portable cellular telephone of claim 1 wherein said data placed in said memory by said scanning device can be edited using said input keys.

10. The portable cellular telephone of claim 1 wherein the scanning device is an optical scanner.

11. The portable cellular telephone of claim 1 wherein the scanning device is a bar code reader.

12. The portable cellular telephone of claim 1 wherein the data memory stores alpha and numeric data.

13. A portable hand-held telephone having a handset with a palm-side designed to be held in a palm of a person and a user interface side, the portable hand-held telephone comprising:
a portable telephone housing having a receptacle adapted to hold a hands-free headset.

14. The portable hand-held telephone of claim 13 further comprising a hands-free headset having an earpiece and a microphone connected to said housing.

15. The portable hand-held telephone of claim 13 wherein said receptacle is configured to match the contours of said hands-free headset.

16. The portable hand-held telephone of claim 14 wherein the headset has an adjustable length.

17. The portable hand-held telephone of claim 16 wherein the headset length adjusts to fit the receptacle.

18. The portable hand-held telephone of claim 16 wherein the headset length adjusts to fit a speaker near a user's ear and a microphone near a user's mouth.

19. The portable hand-held telephone of claim 13 wherein the receptacle is a clip connected to said housing.

20. The portable hand-held telephone of claim 13 wherein the receptacle is positioned on the palm-side of the housing.

21. The portable hand-held telephone of claim 13 wherein the receptacle is positioned on a side other than the palm-side of the housing.

22. The portable hand-held telephone of claim 13 wherein the receptacle is integrally formed in said housing.

23. The portable hand-held telephone of claim 13 further comprising an attachment mechanism for holding the headset in the receptacle and releasing the headset from the receptacle.

24. The portable hand-held telephone of claim 13 wherein the headset is connected to the handset with a cord.

25. The portable hand-held telephone of claim 24 wherein the cord is detachable from the handset.

26. The portable hand-held telephone of claim 24 wherein the cord is retractable into the handset.

27. The portable hand-held telephone of claim 24 wherein the cord is manually wound onto the handset.

28. The portable hand-held telephone of claim 24 wherein the cord is retractable into the handset by a spring winding mechanism.

29. The portable hand-held telephone of claim 24 wherein the cord is retractable into the handset by a motorized winding mechanism.

30. The portable hand-held telephone of claim 24 further comprising a retraction button for retracting the cord into the handset when the retraction button is pressed.

31. The portable hand-held telephone of claim 24 further comprising a retraction button for retracting the cord into the handset while the retraction button is pressed.

32. A portable hand-held cellular telephone having a top portion and a bottom portion, the portable hand-held cellular telephone comprising:
a telephone housing;
a speaker for generating an audible signal positioned in a top portion of said housing;
a microphone for receiving an audible signal positioned in a bottom portion of said housing;
a set of keys for entering data proximately located on said housing adjacent the speaker in said top portion; and,
a display for viewing data positioned below the set of keys and proximately located on said housing adjacent the microphone in said bottom portion.

33. The portable hand-held cellular telephone of claim 32 wherein the keys have a triangular shape.

34. The portable hand-held cellular telephone of claim 33 wherein the keys are positioned in the top portion of the telephone at angles to maximize the space between the keys.

35. The portable hand-held cellular telephone of claim 32 wherein the display is an LCD display.

36. The portable hand-held cellular telephone of claim 32 wherein the display is an LED display.

37. The portable hand-held cellular telephone of claim 32 wherein the display illuminates.

38. The portable hand-held cellular telephone of claim 32 further comprising a receptacle for removably attaching a headset.

39. The portable hand-held cellular telephone of claim 32 further comprising a scanning mechanism connected to said housing.

40. The portable hand-held cellular telephone of claim 32 comprising a hinge connecting said top portion and said bottom portion.

41. A portable hand-held cellular phone comprising
a first top portion having a speaker and a set of input keys, and
a second bottom portion having a display and a microphone, said display positioned below said input keys.

42. The portable hand-held cellular telephone of claim 41 wherein the keys have a triangular shape.

43. The portable hand-held cellular telephone of claim 41 wherein the keys are positioned in the top portion of the telephone at angles to maximize the space between the keys.

44. The portable hand-held cellular telephone of claim 41 wherein the display is an LCD display.

45. The portable hand-held cellular telephone of claim 41 wherein the display is an LED display.

46. The portable hand-held cellular telephone of claim 41 wherein the display illuminates.

47. The portable hand-held cellular telephone of claim 41 comprising a hinge connecting said top portion and said bottom portion.

48. A portable cellular telephone having a memory function comprising:
a cellular telephone housing having a set of input keys and a display;
a speaker for generating an audible signal within a first portion of said housing, and a microphone for receiving an audible signal within a second portion of said housing; and,
an infrared transmitting device connected to said housing for communicating data from a memory within said housing to a receiving device outside of said telephone.

49. The portable cellular telephone of claim 48 further comprising:
an infrared receiving device connected to said housing for receiving data from a transmitting device outside of said telephone.

50. The portable cellular telephone of claim 48 wherein said data is credit card information.

51. The portable cellular telephone of claim 48 wherein said data is a telephone number.

52. The portable cellular telephone of claim 50 wherein said telephone is configured to deny access to said credit card information upon receipt of a designated code.

53. The portable cellular telephone of claim 48 wherein said telephone is configured to only call a preprogrammed number upon receipt of a designated code.
